(19) United States
(12) Patent Application Publication
(10) Pub. No.: US 2024/0248633 A1
(43) Pub. Date: Jul. 25, 2024

(54) Apparatuses, Devices, Methods and Computer Programs for Providing and Processing Information Characterizing a Non-Uniform Memory Architecture

(71) Applicant: Intel Corporation, Santa Clara, CA (US)

(72) Inventors: Francesc GUIM BERNAT, Barcelona (ES); Karthik KUMAR, Chandler, AZ (US); Marcos CARRANZA, Portland, OR (US); Rajesh POORNACHANDRAN, Portland, OR (US); Thomas WILLHALM, Sandhausen (DE)

(21) Appl. No.: 18/477,573

(22) Filed: Sep. 29, 2023

(51) Int. Cl. G06F 3/06

(52) U.S. Cl. CPC G06F 3/0653; G06F 3/0604; G06F 3/0683

(57) ABSTRACT

Various examples of the present disclosure relate to apparatuses, devices, methods, and computer programs for providing and processing information characterizing a non-uniform memory architecture. An apparatus for a computer system comprises processing circuitry to determine a presence of one or more memory devices connected to at least one processor of the computer system via a serial communication-based processor-to-memory interface, the one or more memory devices being part of a non-uniform memory architecture used by the computer system, determine at least one characteristic for the one or more memory devices by estimating or measuring a performance of the one or more memory devices as observed by the at least one processor, and provide information on the at least one characteristic of the one or more memory devices as part of information characterizing the non-uniform memory architecture.

### BACKGROUND

Current operating systems specify NUMA (Non-Uniform Memory Architecture) by reading from a static structure called the SLIT (System Locality Information Table) table. This table is used by the operating system, which reads the table and populates NUMA distances for native DDR (Double Data Rate) memory, by socket, to applications.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for a computer system, and of the computer system comprising the apparatus or device;

FIG. 1b shows a flow chart of an example of a method for a computer system;

FIG. 2a shows a schematic diagram of an example of another apparatus or device for a computer system, and of the computer system comprising the apparatus or device;

FIG. 2b shows a flow chart of an example of another method for a computer system;

FIG. 3 shows an example output of the numatcl command;

FIG. 4 shows an example of the use of near memory, medium memory and far memory;

FIG. 5 shows a schematic diagram of an example of a proposed architecture;

FIG. 6 shows a schematic diagram of an example of extensions to a pre-boot CDAT extraction method for CXL devices; and

FIG. 7 shows a schematic diagram of an example of extensions to an operating system CDAT extraction method for CXL devices.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

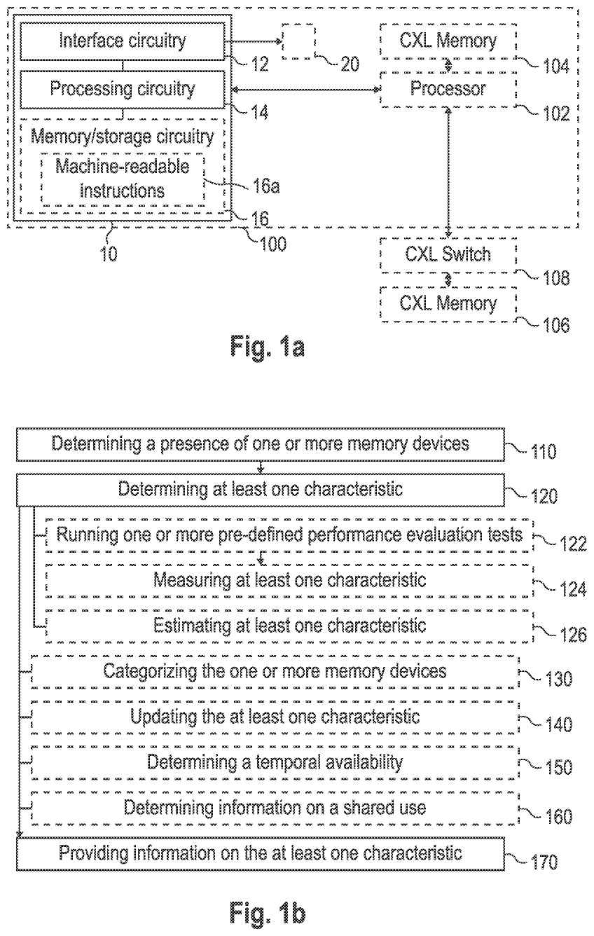

FIG. 1a shows a schematic diagram of an example of an apparatus 10 or device for a computer system 100, and of the computer system 100 comprising the apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processing circuitry 14 (which may correspond to a processor 102 of the computer system 100 or be separate from the processor 102 of the computer system 100), and (optional) memory/storage circuitry 16. For example, the processing circuitry 14 may be coupled with the interface circuitry 12 and/or with the memory/storage circuitry 16. For example, the processing circuitry 14 may provide the functionality of the apparatus, in conjunction with the interface circuitry 12 (for communicating with other entities inside or outside the computer system 100), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processing circuitry 14, means for communicating 12, which may correspond to or be implemented by the interface circuitry 12, (optional) means for storing information 16, which may correspond to or be implemented by the memory or storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions 16a, e.g., within the memory or storage circuitry 16 or means for storing information 16. For example, the apparatus 10 or device 10 may be a baseband management controller of the computer system. A baseband management controller is a specialized microcontroller that is commonly used in computer systems for remote monitoring and management of hardware components. It may act as a separate management subsystem and provides out-of-band communication capabilities with the computer system hardware, e.g., even when the computer system is powered off or the operating system is unresponsive.

The processing circuitry 14 or means for processing 14 is to determine a presence of one or more memory devices 104, 106 connected to at least one processor 102 of the computer system via a serial communication-based processor-to-memory interface. The one or more memory devices are part of a non-uniform memory architecture used by the computer system. The processing circuitry 14 or means for processing 14 is to determine at least one characteristic for the one or more memory devices by estimating or measuring a performance of the one or more memory devices as observed by the at least one processor. The processing circuitry 14 or means for processing 14 is to provide information on the at least one characteristic of the one or more memory devices as part of information characterizing the non-uniform memory architecture.

FIG. 1b shows a flow chart of an example of a corresponding method for the computer system 100. The method comprises determining 110 the presence of the one or more memory devices 104, 106 connected to the at least one processor 102 of the computer system via the serial communication-based processor-to-memory interface. The method comprises determining 120 the least one characteristic for the one or more memory devices by estimating or measuring a performance of the one or more memory devices as observed by the at least one processor. The method comprises providing 170 the information on the at least one characteristic of the one or more memory devices as part of information characterizing the non-uniform memory architecture. For example, the method may be performed by the computer system 100, e.g., by the baseband management controller 10 of the computer system 100.

In the following, the features of the apparatus 10, device 10, computer system 100, method and of a corresponding computer program will be introduced in more detail with reference to apparatus 10. Features introduced in connection with apparatus 10 may likewise be applied to the corresponding device 10, computer system 100, method and computer program.

Various examples of the present disclosure relate to the management of memory devices, and in particular to the management of memory devices of a non-uniform memory architecture (NUMA) that are connected to the at least one processor 102 of the computer system 100 via a serial-based processor-to-memory interface. Examples will be given with reference to a serial communication-based processor-to-memory interface that is a Compute Express Link (CXL) interface. However, the proposed concept is not limited to CXL, but can be applied to any other serial-based processor-to-memory interface, such as any serial communication-based Peripheral Component Interface express (PCIe)-based interface. Various examples might not relate to the main memory of the computer system, i.e., Dynamic Random Access Memory (DRAM) that is connected to the at least one processor via a memory bus or a high bandwidth memory (HBM) interface. In other words, the one or more memory devices might not be part of a main memory of the computer system.

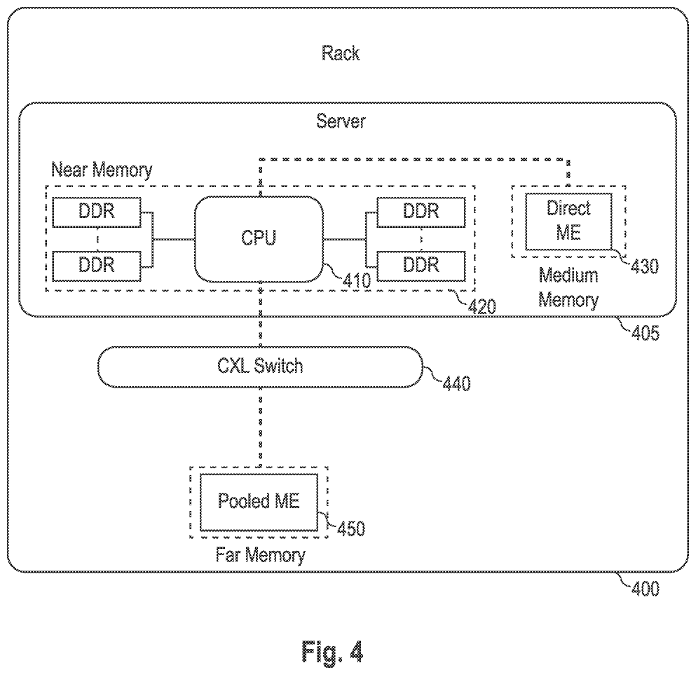

The present concept is based on the finding, that serial-based processor-to-memory interfaces, such as CXL, enable a wide variety of different memory devices, such as memory devices that are based on DRAM, memory devices that include flash memory (and, possibly, DRAM as a cache) that is made accessible like memory (i.e., using memory semantics), non-volatile memory etc. These types of memory devices have in common that they are accessible, via the serial-based processor-to-memory interface, as memory (and not as storage). However, their characteristics, e.g., with respect to bandwidth (i.e., throughput), latency, error rates, power consumption, bandwidth per power consumption etc. vary greatly, resulting in the memory devices being non-uniform with respect to the characteristics, thus creating the non-uniform memory architecture. The differences between the different memory devices are exacerbated by the flexibility of the respective serial-based processor-to-memory interface being used, as some serial-based processor-to-memory interfaces, such as CXL, allow use of so-called switches that can be used to access memory devices that are outside the computer system 100 (e.g., part of another computer system or memory pool hosted in the same rack, as shown in FIG. 4). In FIG. 1a, memory device 104 is part of the computer system 100, while memory device 106 is connected to the processor 102 via CXL switch 108. Such a CXL switch can affect the effective characteristics of the memory device (as perceived by the processor 102), e.g., in terms of throughput, latency, power usage etc. Contrary to other forms of non-uniform memory architectures, which are characterized primarily by the latency incurred for accessing memory that is associated with another processor or processor core, non-uniform memory architectures that are based on serial-based processor-to-memory interface are non-uniform in multiple dimensions, such as the aforementioned latency, throughput, power use and error rate.

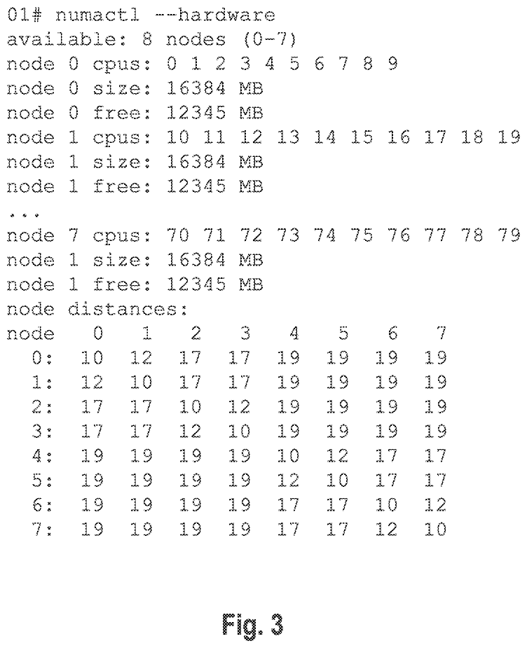

While the latency is, today, expressed through a so-called SLIT (System Locality Information Table) shown in FIG. 3, such a one-dimensional view on the non-uniformity may be considered inadequate with respect to memory devices that are connected to the at least one processor via the serial-based processor-to-memory interface. Moreover, as serial-based processor-to-memory interfaces enable connections to memory devices inside and outside computer system, static information, such as the information stored in the SLIT table by a firmware of the computer system, may also be considered inadequate, as many factors impact the characteristics of the memory devices (as perceived by the at least one processor 102).

Examples of the present disclosure address these inadequacies by moving from a static, one-dimensional system to a multi-dimensional system that attempts to determine the characteristics of the one or more memory devices in a more precise manner, by measuring the characteristics, or by estimating the characteristics based on known characteristics of the memory devices and the topology of the serial-based processor-to-memory interface/bus. This may enable provisioning of information on the non-uniform memory architecture that more accurately reflects the characteristics of the respective memory devices.

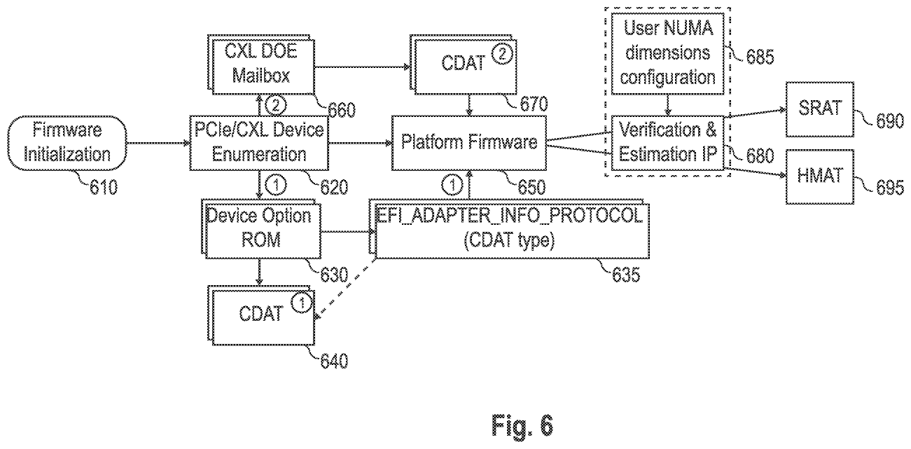

The proposed process starts at system initialization, by determining the presence of the one or more memory devices 104; 106 connected to at least one processor 102 of the computer system via a serial communication-based processor-to-memory interface. As shown in FIG. 6, this detection can be implemented similar to the process being used to populate the so-called CDAT (Coherent Device Attribute Table), e.g., as part of PCIe/CXL device enumeration 620. Memory device enumeration is not limited to memory devices 104 that are part of the computer system 100 but can also be used to determine the presence (and enumerate) one or more memory devices outside the computer system, e.g., one or more memory devices that are connected to the at least one processor 102 via a (CXL) switch, which may affect latency, throughput and/or power consumption of using the memory device. For example, the one or more memory devices 102, 104 may be memory devices for communicating via the serial-based processor-to-memory interface, e.g., CXL memory devices. For example, the one or more memory devices 102, 104 may be memory devices being accessed using memory semantics, not storage semantics.

The processing circuitry is to determine the at least one characteristic for the one or more memory devices by estimating or measuring a performance of the one or more memory devices as observed by the at least one processor. In general, various characteristics of the one or more memory devices can be determined, such as one or more of the aforementioned latency, throughput, power consumption, power consumption per throughput, and error rate.

To determine the at least one characteristic in a more precise manner, at least some characteristic(s) may be measured (instead of estimated.), e.g., using a pre-defined performance evaluation test (i.e., “benchmark”). In other words, the processing circuitry may determine the at least one characteristic at least partially (i.e., at least one of a plurality of characteristics) by running (i.e., executing) one or more pre-defined performance evaluation tests on the one or more memory devices, i.e., by having the at least one processor run the one or more pre-defined performance evaluation tests on the one or more memory devices.

Accordingly, as further shown in FIG. 1b, the method may comprise determining 120 the at least one characteristic at least partially by running 122 one or more pre-defined performance evaluation tests on the one or more memory devices. This approach may be used to determine characteristics that are measurable, such as latency, throughput, error rate and/or power consumption. In other words, the processing circuitry may determine at least one of the latency, the throughput between the at least one processor and the memory device, the error rate, and the power consumption of the memory device by measuring the respective latency, throughput, error rate or power consumption, e.g., as part of the one or more pre-defined performance evaluation tests. Accordingly, as further shown in FIG. 1b, the method may comprise determining 120 at least one of the latency, the throughput between the at least one processor and the memory device, the error rate, and the power consumption of the memory device by measuring 124 the respective latency, throughput, error rate or power consumption. For example, latency, bandwidth, and error rate may be measured using a software test, while power consumption may be measured using measurement hardware of the computer system and/or of the respective memory device (and possible switch(es) between the processor and the respective memory device).

Alternatively, or additionally (as a preliminary estimate), estimation may be used to at least partially (i.e., at least one of a plurality of characteristics) determine the at least one characteristic. For example, if a maximal, average and/or minimal throughput of the one or more memory devices (or memory technology, form factor and/or connectivity thereof, from which the throughput can be estimated) and the serial-based processor-to-memory interface (including possible switches) between the at least one processor and the one or more memory devices, a latency of the one or more memory devices (or memory technology, form factor and/or connectivity thereof, from which the latency can be estimated) and of the interface (including possible switches) between the at least one processor and the one or more memory devices, and/or a maximal, average and/or minimal power consumption of the one or more memory devices and of the serial-based processor-to-memory interface (including possible switches) is/are known, at least some characteristics can be estimated by calculating them based on at least one of the maximal, average and/or minimal throughput, latency and/or power consumption. In other words, the processing circuitry may determine the at least one characteristic of a memory device at least partially by estimating the characteristic based on at least one of the memory technology used by the memory device, a form factor used by the memory device, a connectivity of the memory device, a known reliability of the memory device and a known power-consumption of the memory device. Accordingly, as further shown in FIG. 1b, method may comprise determining 120 the at least one characteristic of a memory device at least partially by estimating 126 the characteristic based on at least one of the memory technology used by the memory device (which affects the throughput and latency), the form factor used by the memory device (which affects at least the latency), a connectivity of the memory device (which affects the throughput and latency of the memory device), a known reliability of the memory device and a known power-consumption of the memory device.

In some examples, the processing circuitry may combine both approaches-estimate the at least one characteristic initially, and then refine the at least one characteristic after measurements have been performed. Similarly, even when a characteristic has been determined by measurement, it may change over time (due to heat, load, or number of active memory devices on the serial-based processor-to-memory interface), so the measurements may be repeated over time (at runtime). The processing circuitry may update the information on the at least one characteristic based on runtime re-evaluation of the at least one characteristic (e.g., using the aforementioned one or more pre-defined performance evaluation tests). Accordingly, as further shown in FIG. 1b, the method may comprise updating 140 the information on the at least one characteristic based on runtime re-evaluation of the at least one characteristic.

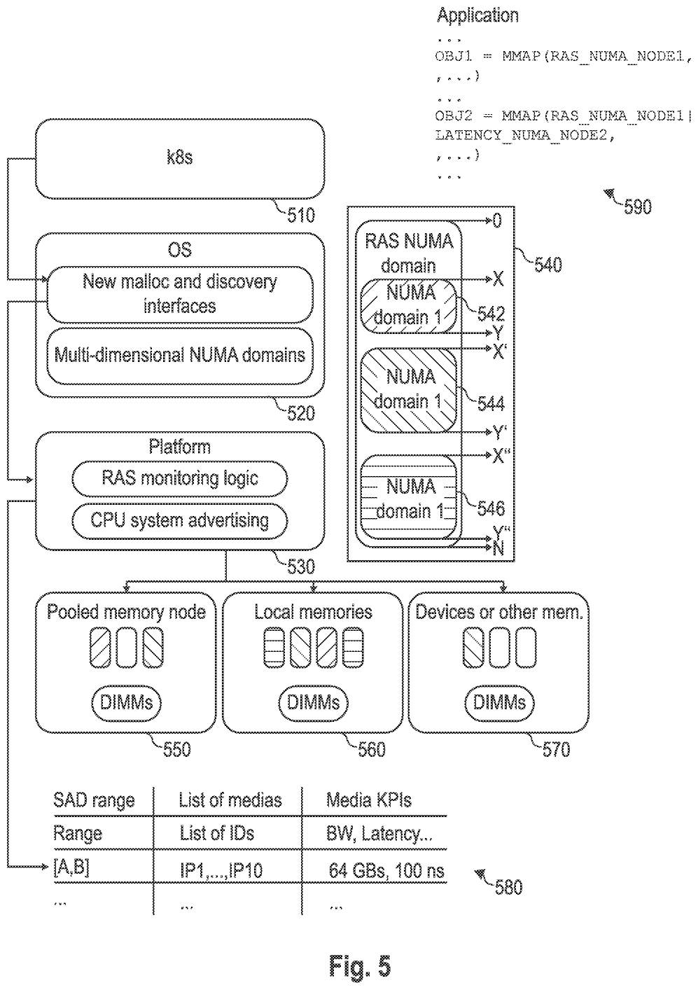

In many cases, the raw numbers characterizing the respective memory devices are not of vital importance, as small differences between different memory devices have a limited impact on the application software using the respective memory provided by the memory devices. In many cases it suffices to categorize the different memory devices into different categories (also denoted “NUMA performance domains” in the present disclosure), such as low latency, medium latency and high latency, low throughput, medium throughput and high throughput, low bit error rate, medium bit error rate, high bit error rate, low power consumption/throughput, medium power consumption/throughput, high power consumption/throughput. Therefore, the different memory devices may be categorized into such categories, which may facilitate selection of memory provided by the respective memory devices by the application software. For example, the processing circuitry may categorize each of the one or more memory devices into (at least) one of two or more non-uniform memory architecture performance domains (i.e., categories) according to at least one characteristic. Accordingly, as further shown in FIG. 1b, the method may comprise categorizing 130 each of the one or more memory devices into (at least) one of two or more non-uniform memory architecture performance domains according to at least one characteristic. As, ideally, multiple different performance characteristics are evaluated, each memory device may be categorized into multiple non-uniform memory architecture performance domains, one for each characteristic (also denoted “dimension” in the present disclosure.) In other words, the processing circuitry may determine at least two characteristics for each memory device, and to categorize, separately for each of the at least two characteristics (i.e., for each of at least two characteristics), each of the one or more memory devices into one of two or more non-uniform memory architecture performance domains for the respective characteristic. The information on the at least one characteristic may be provided with information on the categorization, i.e., with information on the at least one non-uniform memory architecture performance domain each memory device is categorized in. This information may be used by the respective application to reserve memory. For example, as shown in the application 590 shown in FIG. 5, the memory map (mmap) command may take one or more non-uniform memory architecture performance domains as input parameters when reserving memory on one of the one or more memory devices.

Apart from the aforementioned characteristics, two additional factors that affect usage of memory devices is their temporal availability (i.e., whether a memory device is available temporarily or only for a (known) finite time interval) and whether the memory device is being shared between different computer systems. Therefore, the non-uniform memory architecture characteristics, attributes and/or dimensions may be extended to characterize the memory devices with respect to memory pooling and memory sharing. With CXL, memory can be borrowed (e.g., for 2 days, or 1 week, or 2 weeks) with pooling, and shared between multiple nodes. In the following, some examples of attributes that may be exposed to software are given. For example, with pooling, the time the individual NUMA nodes (i.e., memory devices) are available may be categorized into different categories (e.g., permanent local memory, available for more than 1 day, available for more than one week), with a list of NUMA nodes being maintained for each category (which may overlap). For example, the category “permanent local memory” may list NUMA nodes 0,1, “available for more than 1 day” may list NUMA nodes 2, 3, 4, 5 and the category “available for more than 1 week” may list NUMA nodes 3, 4. With sharing, the amount of sharing being applied on the respective NUMA nodes may be categorized, e.g., into exclusive local memory, shared with 1-5 tenants and shared with more than 10 tenants. For example, the category “exclusive local memory” may list NUMA nodes 0,1, “shared with 1-5 tenants” may list NUMA node 2 and the category “shared with more than 10 tenants” may list NUMA nodes 3, 4. In summary, the processing circuitry may determine a temporal availability of the one or more memory devices and/or information on a shared use of the one or more memory devices. Accordingly, as further shown in FIG. 1b, the method may comprise determining 150 the temporal availability of the one or more memory devices, and/or determining 160 the information on the shared use of the one or more memory devices. The information on the at least one characteristic may then be provided with information on the temporal availability of the one or more memory devices and/or with information on the shared use of the one or more memory devices.

Once the information on the at least one characteristic is compiled, it is provided, e.g., to an operating system or hypervisor (both denoted as abstract block 20 in FIG. 1a). In other words, the processing circuitry may provide the information on the at least one characteristic to at least one of an operating system of the computer system and a hypervisor of the computer system. In general, the information on the at least one characteristic may be used to extend known NUMA information, such as the System Resource Affinity Table (SRAT), Heterogeneous Memory Attribute Table (HMAT), System Locality Distance Information Table (SLIT), or operating system-specific variations or copies thereof (which constitute information characterizing the NUMA). For example, the SLIT is a table provided by/via the Advanced Configuration and Power Interface (ACPI), describing the relative differences in access latency between NUMA nodes. The HMAT is another table provided by/via the ACPI, which describes the bandwidth and latency from an initiator (a processor or accelerator) to a memory target. SRAT is a table describing NUMA domains in a system, including processor, accelerators, and memory. For example, the information on the at least one characteristic may be provided as part of at least one of the SRAT, HMAT and SLIT, or operating system-specific variations or copies thereof. The information being provided comprises at least one of the characteristics discussed above. For example, the information on the at least one characteristic of the one or more memory devices may be provided, for each memory device, with at least one of (or at least two of) the latency between the at least one processor and the memory device, the throughput between the at least one processor and the memory device, the power consumption caused by using the memory device by the at least one processor, the throughput between the at least one processor and the memory device per computer consumption, and the error rate of the use of the memory device by the one or more processors. As was discussed with respect to the categorization of a memory device into per-dimension performance domains, the proposed concept is particularly beneficial if more than one characteristic is provided per memory device. Accordingly, the information on the at least one characteristic of the one or more memory devices may be provided, for each memory device, with at least two characteristics, e.g., with a categorization of each memory device in performance domains in at least two dimensions.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the processor 102 may be one of a Central Processing Unit (CPU), a Graphics Processing Unit (GPU), a Field-Programmable Gate Array (FPGA), a Digital Signal Processor (DSP) and an Application-Specific Integrated Circuit (ASIC).

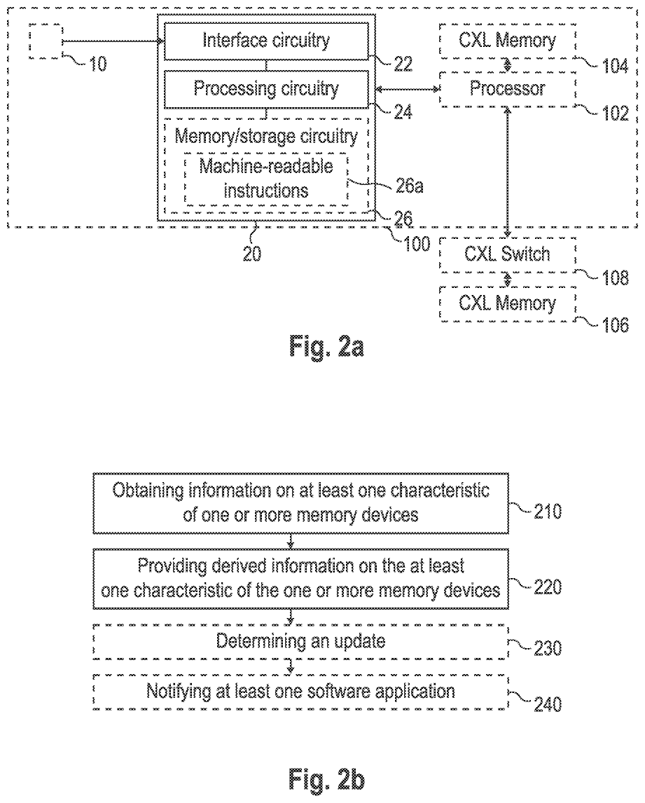

More details and aspects of the apparatus 10, device 10, computer system 100, system, method and computer program are mentioned in connection with the proposed concept, or one or more examples described above or below (e.g., FIGS. 2a to 4). The apparatus 10, device 10, computer system 100, system, method and computer program may comprise one or more additional optional features corresponding to one or more aspects of the proposed concept, or one or more examples described above or below.

For example, the computer system 100 may be one of a server computer system, a workstation computer system, and a rackmount computer system. For example, the computer system 100 may be operated as part of a rack of computer systems, the rack further comprising a pool of memory devices 106.

More details and aspects of the apparatus 10, device 10, computer system 100, method and computer program are mentioned in connection with the proposed concept, or one or more examples described above or below (e.g., FIGS. 2a to 7). The apparatus 10, device 10, computer system 100, method and computer program may comprise one or more additional optional features corresponding to one or more aspects of the proposed concept, or one or more examples described above or below.

FIG. 2a shows a schematic diagram of an example of another apparatus 20 or device 20 for a computer system 100 (e.g., the computer system 100 of both FIGS. 1a and 1b), and of the computer system 100 comprising the apparatus or device 20. The apparatus 20 comprises circuitry to provide the functionality of the apparatus 20. For example, the circuitry of the apparatus 20 may be configured to provide the functionality of the apparatus 20. For example, the apparatus 20 of FIG. 2a comprises interface circuitry 22, processing circuitry 24 (which may correspond to a processor 102 of the computer system 100 or be separate from the processor 102 of the computer system 100, such as the apparatus 10 or device 10), and (optional) memory/storage circuitry 26. For example, the processing circuitry 24 may be coupled with the interface circuitry 22 and/or with the memory/storage circuitry 26. For example, the processing circuitry 24 may provide the functionality of the apparatus, in conjunction with the interface circuitry 22 (for communicating with other entities inside or outside the computer system 100), and the memory/storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIG. 2a comprises means for processing 24, which may correspond to or be implemented by the processing circuitry 24, means for communicating 22, which may correspond to or be implemented by the interface circuitry 22, (optional) means for storing information 26, which may correspond to or be implemented by the memory or storage circuitry 26. In general, the functionality of the processing circuitry 24 or means for processing 24 may be implemented by the processing circuitry 24 or means for processing 24 executing machine-readable instructions. Accordingly, any feature ascribed to the processing circuitry 24 or means for processing 24 may be defined by one or more instructions of a plurality of machine-readable instructions. The apparatus 20 or device 20 may comprise the machine-readable instructions 26a, e.g., within the memory or storage circuitry 26 or means for storing information 26.

The processing circuitry 24 or means for processing 24 is to obtain information on at least one characteristic of one or more memory devices 104, 106 of a non-uniform memory architecture used by the computer system 100 as part of information characterizing the non-uniform memory architecture, e.g., as discussed in connection with FIGS. 1a and/or 1b. The information on the at least one characteristic is based on an estimate or measurement of the performance of the one or more memory devices as observed by at least one processor 102 of the computer system 100, with the one or more memory devices being connected to the at least one processor of the computer system via a serial communication-based processor-to-memory interface. The processing circuitry 24 or means for processing 24 is to provide derived information on the at least one characteristic of one or more memory devices for use in memory allocation.

FIG. 2b shows a flow chart of an example of a corresponding method for the computer system 100. The method comprises obtaining 210 the information on the at least one characteristic of one or more memory devices of a non-uniform memory architecture used by the computer system as part of the information characterizing the non-uniform memory architecture. The method comprises providing 220 the derived information on the at least one characteristic of one or more memory devices for use in memory allocation. For example, the computer system 100 may perform the method of FIG. 2b and/or the method of FIG. 1a. In particular, a hypervisor or operating system of the computer system 100 may perform the method of FIG. 2b.

In the following, the features of the apparatus 20, device 20, computer system 100, method and of a corresponding computer program will be introduced in more detail with reference to apparatus 20. Features introduced in connection with apparatus 20 may likewise be applied to the corresponding device 20, computer system 100, method and computer program.

While FIGS. 1a and/or 1b relates to the entity measuring or estimating the characteristics of the different memory devices, FIGS. 2a and 2b relate to the entity, such as the hypervisor or operating system, exposing the characteristics to application programs. The apparatus 20 provides abstract interfaces for discovering the memory provided by the one or more memory devices (and the characteristics thereof), and improved interfaces for reserving memory on the one or more memory devices, e.g., interfaces that enable reserving memory according to a NUMA performance domain desired by the respective application program.

The processing circuitry 24 is to obtain the information on the at least one characteristic the of one or more memory devices 104, 106 of the non-uniform memory architecture used by the computer system 100 as part of information characterizing the non-uniform memory architecture, e.g., the information provided by the apparatus 10 discussed in connection with FIGS. 1a. For example, as discussed in connection with FIG. 1a, the information on the at least one characteristic may be obtained from a baseband management controller, e.g., via the ACPI. In particular, the information on the at least one characteristic may be obtained from/via at least one of the SRAT, HMAT and SLIT provided via the ACPI.

The information on the at least one characteristic is then transformed to generate the derived information on the at least one characteristic of one or more memory devices, which is suitable for use in memory allocation. In particular, the processing circuitry may provide the derived information on the at least one characteristic of one or more memory devices via at least one of two mechanism-by providing information on the one or more memory devices being available (and their respective characteristics), and by providing an interface (e.g., an application programming interface) for reserving/allocating memory provided by the one or more memory devices for an application program. The former mechanism may be used by application programs to discover what kind of memory (i.e., memory with which characteristics) is available. The latter mechanism may be used to reserve/allocate memory having a specified characteristic, e.g., according to at least one NUMA performance domain.

In the following, the focus is on the mechanism for reserving/allocating memory. In general, one objective may be to provide a mechanism that lets application developers easily reserve/allocate memory with a desired performance layer across one or several dimensions. For example, as shown in the application 590 shown in FIG. 5, the processing circuitry may provide an (application programming) for reserving/allocating memory according to one or more NUMA performance domains along one or more dimensions. For example, in the example given in FIG. 5, memory map instructions are called that take the NUMA performance domain(s) as parameter. In the first example, the first domain along the RAS (Reliability, Availability, Serviceability) dimension, i.e., error rate, is given as parameter, in the second example, the first domain along the RAS (Reliability, Availability, Serviceability) dimension and the second domain along the latency dimension is given as a parameter. The processing circuitry may provide an (application programming) interface (e.g., implementing the mmap and/or malloc command(s)) for reserving/allocating memory that takes the desired characteristic (e.g., NUMA performance domain(s)) as parameter.

As shown in the second example, this is particularly desirable when multiple dimensions (i.e., characteristics) are supported, i.e., if the information on the at least one characteristic of the one or more memory devices is obtained, for each memory device, with at least two characteristics. As outlined in connection with FIGS. 1a and 1b, the information on the at least one characteristic may comprise information on a categorization of the one or more memory devices in one of two or more non-uniform memory architecture performance domains, with each NUMA performance domain being aligned with/based on at least one characteristic. The derived information may be provided with the information on the categorization of the one or more memory devices. In this particular implementation, the interface may be provided with an option to reserve/allocate memory provided by a memory device according to the categorization of the memory device. The processing circuitry may select a memory device according to the NUMA performance domain of the memory device and the NUMA performance domain specified, by an application software, as a parameter when using the interface. If no NUMA performance domain is specified by the calling application software, any memory from any memory device may be selected.

Two other factors when allocating memory is the temporal availability and the shared use of the one or more memory devices. For example, the information on the at least one characteristic may be obtained with information on a temporal availability of the one or more memory devices, and the derived information on the at least one characteristic may be provided with the information on the temporal availability. Similarly, the information on the at least one characteristic may be obtained with information on a shared use of the one or more memory devices, and the derived information on the at least one characteristic may be provided with the information on the shared use. Similar to above, the interface may be provided with an option for the application program to provide a parameter regarding temporal availability or shared use, e.g., so that the memory having a specific characteristic with respect to temporal availability and/or shared use can be reserved.

In some cases, the characteristics of memory devices may change over time, e.g., as a characteristic that was initially based on an estimate is refined after a measurement has been conducted, or as the characteristic changes between subsequent measurements. In this case, the information on the characteristic may be updated, e.g., by the baseband management controller. For example, the processing circuitry may determine an update to the information on the at least one characteristic (e.g., receive information on the information on the at least one characteristic being update, or detect the update by comparing subsequent versions of the information on the at least one characteristic), with the update being based on runtime re-evaluation of the at least one characteristic. In this case, the software application(s) using memory provided by a memory device whose characteristics have been updated may be notified of the changed characteristic(s), enabling the software application to react to the update (e.g., by reserving/allocating memory on a different memory device). Thus, the processing circuitry may notify at least one software application having performed memory allocation based on the derived information on the at least one characteristic of the update. Accordingly, as further shown in FIG. 2b, the method may comprise determining 230 the update to the information on the at least one characteristic being based on runtime re-evaluation of the at least one characteristic and notifying 240 the at least one software application having performed memory allocation based on the derived information on the at least one characteristic of the update.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processing circuitry 24 or means for processing 24 may be implemented using one or more processing units, one or more processing devices, any means for processing, such as a processor, a computer or a programmable hardware component being operable with accordingly adapted software. In other words, the described function of the processing circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 26 or means for storing information 26 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 20, device 20, computer system 200, system, method and computer program are mentioned in connection with the proposed concept, or one or more examples described above or below (e.g., FIGS. 2a to 4). The apparatus 20, device 20, computer system 200, system, method and computer program may comprise one or more additional optional features corresponding to one or more aspects of the proposed concept, or one or more examples described above or below.

More details and aspects of the apparatus 20, device 20, computer system 100, method and computer program are mentioned in connection with the proposed concept, or one or more examples described above or below (e.g., FIGS. 1a to 1b, 3 to 7). The apparatus 20, device 20, computer system 100, method and computer program may comprise one or more additional optional features corresponding to one or more aspects of the proposed concept, or one or more examples described above or below.

Various examples of the present disclosure relate to a concept for multi-dimensional CXL software NUMA abstractions.

Current operating systems specify NUMA by reading from a static structure called the SLIT table; this is used by the operating system, which reads this table and populates NUMA distances for native DDR memory, by socket, to applications. For example, the result of the numactl command for reading the SLIT table is shown in FIG. 3.

In the example shown in FIG. 3, node 0 comprises CPUs (Central Processing Units) 0 to 7 and has a total of 16 GB of memory. The table at the bottom represents the System Locality Information Table (SLIT). Hardware manufacturers populate the SLIT in the lower firmware layers and provide it to the kernel via the Advanced Configuration and Power Interface (ACPI). It gives the normalized “distances” or “costs” between the different NUMA nodes. Note that this is relative. If a process running in NUMA node 0 needs 1 nanosecond (ns) to access local pages, it will take 1.2 ns to access pages located in remote node 1, 1.7 ns for pages in nodes 2 and 3, and 1.9 ns to access pages in nodes 4-7. On some servers, ACPI does not provide SLIT table values, and the Linux kernel populates the table with arbitrary numbers like 10, 20, 30, 40; these are not accurate relative to each other and are not representative of anything.

With CXL (Compute eXpress Link), a wide variety of type 3 memory devices are supported. For example, CXL supports memory-semantic SSDs (Solid State Drives), based on Negative And (NAND) flash memory, that communicate based on the CXL protocol, which may increase the performance over SSDs that are connected via the NVMe (Non-Volatile Memory express), while providing a small-granularity access (64B access) to the SSD. In addition, through the use of SSDs (over volatile memory), the total cost of ownership may be reduced, while retaining a low latency through the use of buffer memory. For example, specialized flash memory (e.g., SSDs) with memory semantics may be designed for use in different fields, such as huge data processing with a focus on sequential reads (for big data analytics or artificial intelligence/deep learning training, with increased capacity/bandwidth) or wider application areas with a focus on random reads and writes, such as for in-memory databases, graph processing, artificial intelligence/machine learning inference and/or memory extension for FaaS (Function as a Service).

As shown in FIG. 4, CXL memory drives may be exposed behind CXL switches or as part of memory pools that are visible to the processor as memory. FIG. 4 shows an example of the use of near memory 420, medium memory 430 and far memory 450. FIG. 4 shows a rack 400 with a server 405. The server includes a CPU 410, which is directly connected to DDRs via a local memory bus that form the near memory 420. In addition, the CPU 410 is connected to medium memory 430, i.e., memory implemented in the same computer system, but not directly connected to the CPU via a memory bus, which is implemented by a direct memory expander. In addition, the CPU 410 is connected to far memory 450 of a pooled memory expander via a CXL switch 440, with the CXL switch 440 and far memory 450 being outside the server. Manufacturers provide purpose-built memory expansion/memory pooling/sharing controllers and solutions for cloud servers, for CXL-attached memory expansion and pooling.

The variations between different CXL memory devices can be grouped in different buckets, e.g., by media technology, by form factor, by connectivity, by reliability and/or by power consumption. For example, CXL memory devices may be based on different media technologies, such as different types of flash technologies, DDR4 and DDR5 timeframe DRAM (Dynamic Random Access Memory) media, PCM (Phase-Change Random Access Memory), etc. For example, CXL memory devices may be based on different form factors, e.g., direct attach CXL drives, CXL riser cards that implement both CXL and DDR4/5 protocols to expose DIMM (Dual In-Line Memory Module) slots (enabling re-use via CXL of old DDR4 DIMMs that may be otherwise recycled/waterfalled, for example), etc. For example, CXL memory devices may be based on different types of connectivity. For example, CXL type3 memory may include local CXL memory, and CXL memory that is connected over a network, including from a memory pool or behind a CXL switch. For example, CXL memory devices may have different reliability characteristics, because of differences in media, which can additionally be amplified because of run time variations including temperatures, traffic, duration of usage, etc. If a CXL device has encountered many correctable errors, this aspect may be exposed to upper levels of the software stack, so they can make intelligent decisions regarding critical data placement. For example, CXL memory devices may have different power characteristics, which leads to different characteristics with respect to bandwidth per watt, which may be an important metric for sustainable software usages-where it may be important to control and track carbon footprint, etc.

Software may benefit from a reliable mechanism to comprehend these variations between CXL memory that exist along the above dimensions-latency, bandwidth, reliability, bandwidth per watt. This way, guest operating systems (OSes), application software, orchestration software, etc. may be able to leverage CXL memory without encountering surprises that may render the use of CXL memories non-viable. Existing SLIT tables might not meet this expectation, as they are populated by motherboard vendors and/or hardware providers who have no idea regarding what is being inserted into CXL slots and how memory might be used. In general, there is no software abstraction to expose different metrics like reliability, bandwidth per watt, latency, bandwidth, etc. for CXL memories to the end user. This lack is addressed by various examples of the present disclosure.

In other systems, only SLIT tables and NUMA distances are exposed, which is limited in scope, and not really a solution to the problem we have outlined. The SLIT tables and NUMA distance provide no means to comprehend the above-referenced variations between CXL memory devices with respect to latency, bandwidth, reliability, and/or bandwidth per watt. Without such information, software is essentially “flying blind” regarding the vast heterogeneity in CXL memories. Some limited vendor specifications are provided via the CXL CDAT (Coherent Device Attribute Table). While CXL CDAT provides a vendor-specified latency and/or bandwidth, this information may not suffice at the system level, as a memory device can be arranged behind a switch, or riser topology, and as the vendor specification can be inaccurate etc.

The proposed concept may expand the current software architecture to allow applications to discover, understand and utilize different memory media (having different characteristics) that are exposed via CXL. For this purpose, different from the SLIT table, the proposed concept may use current system hooks to create multi-dimensional NUMA domains corresponding to different KPIs (Key Performance Indicators, such as latency, bandwidth, bandwidth/watt, correctable error rates etc.).

At a high-level, one or more of the following expansions are proposed. The BMC software stack running on the platform may be responsible for discovering the different media types that are available in the system (i.e., for determining the presence of the one or more memory devices) and their characteristics (i.e., for determining the at least one characteristic for the one or more memory devices). This may be performed using existing CXL protocols that provide access to media characteristics. The BMC may provide interfaces to the operating system to enumerate and list the various types of NUMA domains that are provided by the system (e.g., latency, etc.). The BMC software or the OS stack may be responsible for monitoring over time certain KPIs (i.e., characteristics) for each of the different media (i.e., memory devices) in order to see if their characteristics indicate that the NUMA domains have changed. For example, if a given memory medium has increased the number of correctable errors, it may be mapped to another NUMA domain for the error rate domain. The operating system may be expanded to: (1) provide discovery and a new malloc (memory allocation) interface to the applications to manage memory allocation, and/or (2) provide notifications to the software stack when NUMA domain definitions change based on the real time monitoring (3).

Various examples of the proposed concept may expand current software architectures to allow characterization and monitoring of the different media exposed via the CXL complex and exposing mechanisms to the orchestration and software stack to discover and manage the different media with the know-how on their characteristics.

FIG. 5 shows a schematic diagram of an example of a proposed architecture. FIG. 5 shows an orchestrator 510 (Kubernetes), which uses new malloc and discovery interfaces (being based on multi-dimensional NUMA domains 540) provided by the operating system 520. The OS uses the RAS (Reliability, Availability and Serviceability) monitoring logic and CPU system advertising provided by the platform 530. The platform accesses the various types of media, such as pooled memory nodes 550 (with DIMMs), local memories 560 (with DIMMs) and devices or other memories 570 (with DIMMs). The pooled memory nodes 550, local memories 560 and devices or other memories 570 provide memory according to different NUMA domains 540. The platform maintains a table 580 with different address ranges (SAD, source address decoder, ranges), list of media, and the different media KPIs. An application 590 may use a memory map (MMAP) command to allocate memory according to different NUMA domains (e.g., RAS domain 1 for Object 1, and RAS domain 1 and latency domain 2 for Object 2).

For example, as shown in FIG. 5, one or more of the following elements may be expanded in the proposed architecture. The BMC software stack (530) or the OS (520) running on the platform may be responsible for discovering the different media types 550, 560, 570 that are available in the system and their characteristics. This discovery may use existing CXL protocols that provide access to media characteristics. Media (memory devices) can provide certain static characteristics that can be provided by the manufacturer, such as performance (bandwidth & latency), power consumption, error rate etc. The BMC software stack or OS may create other type of KPIs (i.e., characteristics) that can be defined during this characterization phase (executed during startup, or periodically, to capture or measure and keep values up to date for some of the required KPIs) and that can be used to define new SAD (Source Address Decoder) NUMA domains, such as GB (bandwidth)/watt etc. For this, the BMC may have access to other telemetry from the platform. The telemetry can be provided by the platform management unit (PMU).

The OS may create the concept of one dimension of NUMA domains. A dimension may comprise, or be defined by, the metric or KPI associated to the dimension (e.g. latency, rate of correctable memory errors occurring or GB/watt), a list of domains that conform to that dimension (a domain may be defined by a range corresponding to that metric (e.g. 10-15 GBs/Watt), and a list of different media that correspond to that domain), a pointer to the list of memory pages that belong to each NUMA domain within this dimension. The OS may expand the current memory structures in a way that is simpler to find memory pages that belong to different NUMA domains for different dimensions. For example, one page may belong to NUMA domain 1 for the Latency dimension and NUMA domain 2 for error rate dimension. For example, memory pages may be tagged with a list of the different NUMA domains they belong to. The operating system may have different hash hierarchies that allow to quickly find pages that have certain properties (e.g., using different tags).

The BMC may provide interfaces to the operating system to enumerate and list the various types of NUMA domains that are provided by the system (e.g., latency, etc.) and the list of NUMA domains inside each of them (if the BMC is responsible for discovering the different media types 550, 560, 570 that are available in the system and their characteristics). The enumeration may include for each dimension a description of the dimension with the corresponding meta-data (e.g., type of metric defining the dimension and properties of that metric, e.g., based on CPUID (central processing unit identification information being exposed by the CPU). In the case of using the CPUID interface, the OS may have a standard way of discovering dimensions in various systems. The enumeration may include for each dimension a list of the different NUMA domains within the dimension and the values or ranges defining those domains.

The operating system may be expanded in order to provide the right interfaces to access to new concept. The operating system 520 may provide discovery and new malloc interfaces to the applications to manage memory allocation. The operating system 520 may provide a set of interfaces that allow to access to the information that has been generated when discovering the different media types 550, 560, 570 that are available in the system and their characteristics. For example, the NUMA operating system definitions, e.g., as used by the Linux operating system, may be expanded in order to incorporate the concept of multi-dimensional NUMA domains. The operating system may monitor how each of the dimensions and NUMA domains evolve over time and make sure that the definition matches the actual behavior. The BMC software or the OS stack may be responsible for monitoring over time certain KPIs for each of the different medias in order to see if their characteristics indicates that the NUMA domains have changed. For example, if a given memory medium has increased the number of correctable errors, it may be mapped to another NUMA domain for the error rate domains. The operating system may provide notifications to the software stacks when NUMA domain definitions change based on the real time monitoring.

The orchestration stack 510 may be expanded in order to allow services or user to require certain characteristics or requirements that can be translated in how to request different NUMA domains for the various dimensions supported in the system. For example, Kubernetes operators can be expanded to discover the various dimensions and domains that the system provides access to. Additionally, or alternatively, Kubernetes plugins can be expanded in order to manage the various media and their dimensions and how they get exposed to services.

In an extension of the proposed concept, on multi-rack type of deployments, once the new SAD NUMA domains are generated, an analysis phase may run to check against non-acceptable thresholds. If a threshold is passed on any of the values, then the platform may evaluate and recommend a better configuration by analyzing other racks that share this data (racks including the same or similar bill of material). If found, the user may be provided with a warning log/message mentioning the BKC (Best Known Configuration, a recommended configuration). Better configurations identification may be implemented by periodically calling tools like Intel® Memory Latency Checker (during idle times)

Various examples of the proposed concept may provide a hypervisor or operating system with the capability for identifying, estimating/verifying, and exposing CXL media types via different attributes to upper layers of the software stack and end users. Given there is a lot of diversity with the CXL memory ecosystem, and CXL vendors can arbitrarily populate specified latencies/bandwidths etc. in their CDAT tables (and would not be able to present accurate end user latencies if for example, CXL memory is arranged behind a switch or other such mechanisms), other systems may leave a gap for system software like operating systems to take this information, independently verify the distances from different XPUs (X-Processing Unit, an abstraction of CPUs, Graphics Processing Units and other types of processing units, such as accelerators), and present this via multi-dimensional NUMA abstractions to end users-including latencies, bandwidths, RAS capabilities, power aspects etc.—customizable by end users.

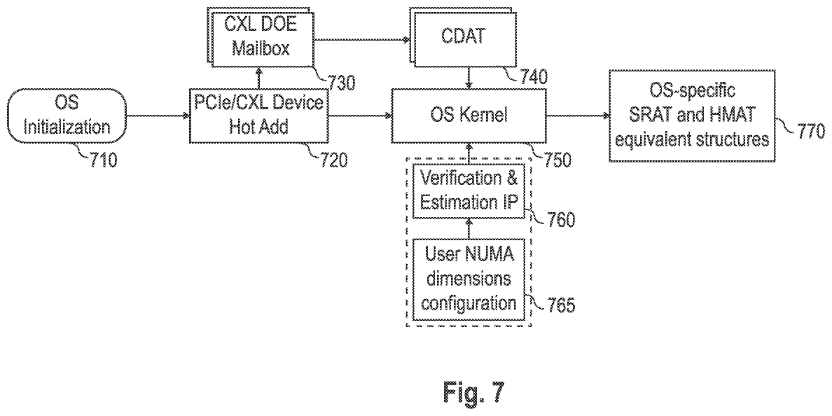

The proposed concept may be integrated into the flow for populating the operating system specific SRAT (System Resource Affinity Table) and HMAT (Heterogeneous Memory Attribute Table) structures. FIGS. 6 and 7 show this integration. Blocks 680 and 685 in FIGS. 6, and 760 and 765 in FIG. 7 have been added to the existing flows. FIG. 6 shows a schematic diagram of an example of extensions to a pre-boot CDAT extraction method for CXL devices. As shown in FIG. 6, at firmware initialization 610, PCIe/CXL device enumeration 620 is performed. Following PCIe (Peripheral Component Interconnect express)/CXL device enumeration 620, two types of CDAT 640; 670 are distinguished: (1) CDAT from devices that implement the option ROM (Read Only Memory) mechanism with EFI_ADAPTER_INFO_PROTOCOL, and (2) CDAT from devices that implement the bus specific mailbox mechanism, in this case the CXL 2.0 DOE (Date Object Exchange) interface. In the first case, the device option ROM 630, e.g., via the EFI_ADAPTER_INFO_PROTOCOL 635, populate the CDAT table 640. In the second case, the CDAT table 670 is populated via the CXL DOE mailbox 660. The information from both CDAT tables 640, 670 is provided to the platform firmware, which populates the SRAT 690 and HMAT 695 tables. In the proposed concept, the information being stored in the SRAT and HMAT tables is enriched by the verification and estimation IP (intellectual property block) 680 (e.g., the apparatus 10 or device 10 shown in FIG. 1a), which is based on user NUMA dimensions configuration 685.

FIG. 7 shows a schematic diagram of an example of extensions to an operating system CDAT extraction method for CXL devices. After operating system initialization 710, at PCIe/CXL device hot add 720, the CXL DOE mailbox 730 is used to populate the CDAT table 740, which is provided to the OS kernel 750. The OS kernel uses the verification and estimation IP block 760, which is based on user NUMA dimensions configurations, to enrich the information from the CDAT table, and to populate the operating system specific SRAT and HMAT equivalent structures.

The proposed concept may enable CXL memory systems to organize CXL memory NUMA more accurately in terms of latencies/bandwidths, or other attributes including RAS NUMA domains, etc.

Various examples of the present disclosure may provide a mechanism (method and apparatus) for system software to publish, for CXL memories, a set of NUMA metrics (e.g., information characterizing the non-uniform memory architecture, including at least one characteristic of one or more memory devices)—such as latency, bandwidth, RAS capability (error rate), power domains, to end users and enable end user selection of metrics of interest from the published list. Given CXL memories involve different media types with large variables for these NUMA metrics, it is important to focus on those of interest to the end user.

Various examples may provide a mechanism for system software to, for a given NUMA metric of interest (memory error rate, for example), monitor the capability of CXL memories (e.g., monitoring memory error rates for the various memories), and maintain an updated RAS NUMA table for example, that exposes run-time RAS NUMA capabilities to end users. The RAS NUMA table may combine vendor provided CDAT, if available, with what the OS actually observes in terms of memory errors and is therefore more accurate. Likewise, if the metric of interest was memory latency, a vendor may publish a device latency of, for example, 200 ns. However, the OS may measure a true latency that may be say 400 ns, possibly because the device is sitting behind a CXL switch. Therefore, the NUMA table provided in the proposed concept may use the operating system-measured values that are more accurate. Since it is possible to expose different NUMA attributes (the non-uniformity in NUMA could be error rates/RAS or latency, or bandwidth, or power-related, etc.), the proposed concept may include multi-dimensional NUMA capability based on metrics selected by end users.

Various examples may provide a mechanism for system SW to handle hot plugging of CXL devices and intercept a hot plugged device with the proposed IP block to figure out how it fits with existing published multi-dimensional RAS NUMA capabilities.

More details and aspects of the concept for multi-dimensional CXL software NUMA abstractions are mentioned in connection with the proposed concept, or one or more examples described above or below (e.g., FIGS. 1a to 2b). The concept for multi-dimensional CXL software NUMA abstractions may comprise one or more additional optional features corresponding to one or more aspects of the proposed concept, or one or more examples described above or below.

In the following, some examples of the proposed concept are presented: An example (e.g., example 1) relates to an apparatus (10) for a computer system (100), the apparatus comprising interface circuitry (12), machine-readable instructions, and processing circuitry (14) to execute the machine-readable instructions to determine a presence of one or more memory devices (104, 106) connected to at least one processor (102) of the computer system via a serial communication-based processor-to-memory interface, the one or more memory devices being part of a non-uniform memory architecture used by the computer system, determine at least one characteristic for the one or more memory devices by estimating or measuring a performance of the one or more memory devices as observed by the at least one processor, and provide information on the at least one characteristic of the one or more memory devices as part of information characterizing the non-uniform memory architecture.

Another example (e.g., example 2) relates to a previous example (e.g., example 1) or to any other example, further comprising that the information on the at least one characteristic is provided as part of at least one of a System Resource Affinity Table (SRAT), Heterogeneous Memory Attribute Table (HMAT) and System Locality Distance Information Table (SLIT).

Another example (e.g., example 3) relates to a previous example (e.g., one of the examples 1 or 2) or to any other example, further comprising that the information on the at least one characteristic of the one or more memory devices is provided, for each memory device, with at least two characteristics.

Another example (e.g., example 4) relates to a previous example (e.g., example 3) or to any other example, further comprising that the information on the at least one characteristic of the one or more memory devices is provided, for each memory device, with at least two of a latency between the at least one processor and the memory device, a throughput between the at least one processor and the memory device, a power consumption caused by using the memory device by the at least one processor, a throughput between the at least one processor and the memory device per computer consumption, and an error rate of the use of the memory device by the one or more processors.

Another example (e.g., example 5) relates to a previous example (e.g., one of the examples 1 to 4) or to any other example, further comprising that the processing circuitry is to execute the machine-readable instructions to provide the information on the at least one characteristic to at least one of an operating system of the computer system and a hypervisor of the computer system.

Another example (e.g., example 6) relates to a previous example (e.g., one of the examples 1 to 5) or to any other example, further comprising that the processing circuitry is to execute the machine-readable instructions to categorize each of the one or more memory devices into one of two or more non-uniform memory architecture performance domains according to at least one characteristic, and to provide the information on the at least one characteristic with information on the categorization.

Another example (e.g., example 7) relates to a previous example (e.g., example 6) or to any other example, further comprising that the processing circuitry is to execute the machine-readable instructions to determine at least two characteristics for each memory device, and to categorize, separately for each of the at least two characteristics, each of the one or more memory devices into one of two or more non-uniform memory architecture performance domains for the respective characteristic.

Another example (e.g., example 8) relates to a previous example (e.g., one of the examples 1 to 7) or to any other example, further comprising that the processing circuitry is to execute the machine-readable instructions to determine the at least one characteristic at least partially by running one or more pre-defined performance evaluation tests on the one or more memory devices.

Another example (e.g., example 9) relates to a previous example (e.g., example 8) or to any other example, further comprising that the processing circuitry is to execute the machine-readable instructions to determine at least one of a latency, a throughput between the at least one processor and the memory device, an error rate, and a power consumption of the memory device by measuring the respective latency, throughput, error rate or power consumption.

Another example (e.g., example 10) relates to a previous example (e.g., one of the examples 1 to 9) or to any other example, further comprising that the processing circuitry is to execute the machine-readable instructions to determine the at least one characteristic of a memory device at least partially by estimating the characteristic based on at least one of a memory technology used by the memory device, a form factor used by the memory device, a connectivity of the memory device, a known reliability of the memory device and a known power-consumption of the memory device.

Another example (e.g., example 11) relates to a previous example (e.g., one of the examples 1 to 10) or to any other example, further comprising that the processing circuitry is to execute the machine-readable instructions to update the information on the at least one characteristic based on runtime re-evaluation of the at least one characteristic.

Another example (e.g., example 12) relates to a previous example (e.g., one of the examples 1 to 11) or to any other example, further comprising that the processing circuitry is to execute the machine-readable instructions to determine a temporal availability of the one or more memory devices, and to provide the information on the at least one characteristic with information on the temporal availability of the one or more memory devices.

Another example (e.g., example 13) relates to a previous example (e.g., one of the examples 1 to 12) or to any other example, further comprising that the processing circuitry is to execute the machine-readable instructions to determine information on a shared use of the one or more memory devices, and to provide the information on the at least one characteristic with information on the shared use of the one or more memory devices.

Another example (e.g., example 14) relates to a previous example (e.g., one of the examples 1 to 13) or to any other example, further comprising that the serial-based processor-to-memory interface is a serial communication-based Peripheral Component Interface express (PCIe)-based interface.

Another example (e.g., example 15) relates to a previous example (e.g., one of the examples 1 to 14) or to any other example, further comprising that the serial communication-based processor-to-memory interface is a Compute Express Link (CXL) interface.

An example (e.g., example 16) relates to an apparatus (10) for a computer system (100), the apparatus comprising processing circuitry (14) configured to determine a presence of one or more memory devices (104, 106) connected to at least one processor (102) of the computer system via a serial communication-based processor-to-memory interface, the one or more memory devices being part of a non-uniform memory architecture used by the computer system, determine at least one characteristic for the one or more memory devices by estimating or measuring a performance of the one or more memory devices as observed by the at least one processor, and provide information on the at least one characteristic of the one or more memory devices as part of information characterizing the non-uniform memory architecture.

An example (e.g., example 17) relates to a device (10) for a computer system (100), the device comprising means for processing (14) for determining a presence of one or more memory devices (104, 106) connected to at least one processor (102) of the computer system via a serial communication-based processor-to-memory interface, the one or more memory devices being part of a non-uniform memory architecture used by the computer system, determining at least one characteristic for the one or more memory devices by estimating or measuring a performance of the one or more memory devices as observed by the at least one processor, and providing information on the at least one characteristic of the one or more memory devices as part of information characterizing the non-uniform memory architecture.

Another example (e.g., example 18) relates to a previous example (e.g., one of the examples 1 to 17) or to any other example, further comprising that the apparatus (10) or device (10) is a baseband management controller.

Another example (e.g., example 19) relates to a computer system comprising the baseband memory controller according to example 18 or the apparatus (10) or device according to one of the examples 1 to 17.

An example (e.g., example 20) relates to a method (10) for a computer system (100), the method comprising determining (110) a presence of one or more memory devices (104, 106) connected to at least one processor (102) of the computer system via a serial communication-based processor-to-memory interface, the one or more memory devices being part of a non-uniform memory architecture used by the computer system, determining (120) at least one characteristic for the one or more memory devices by estimating or measuring a performance of the one or more memory devices as observed by the at least one processor, and providing (170) information on the at least one characteristic of the one or more memory devices as part of information characterizing the non-uniform memory architecture.

Another example (e.g., example 21) relates to a previous example (e.g., example 20) or to any other example, further comprising that the information on the at least one characteristic is provided as part of at least one of a System Resource Affinity Table (SRAT), Heterogeneous Memory Attribute Table (HMAT) and System Locality Distance Information Table (SLIT).

Another example (e.g., example 22) relates to a previous example (e.g., one of the examples 20 or 21) or to any other example, further comprising that the information on the at least one characteristic of the one or more memory devices is provided, for each memory device, with at least two characteristics.

Another example (e.g., example 23) relates to a previous example (e.g., example 22) or to any other example, further comprising that the information on the at least one characteristic of the one or more memory devices is provided, for each memory device, with at least two of a latency between the at least one processor and the memory device, a throughput between the at least one processor and the memory device, a power consumption caused by using the memory device by the at least one processor, a throughput between the at least one processor and the memory device per computer consumption, and an error rate of the use of the memory device by the one or more processors.

Another example (e.g., example 24) relates to a previous example (e.g., one of the examples 20 to 23) or to any other example, further comprising that the information on the at least one characteristic is provided to at least one of an operating system of the computer system and a hypervisor of the computer system.

Another example (e.g., example 25) relates to a previous example (e.g., one of the examples 20 to 24) or to any other example, further comprising that the method comprises categorizing (130) each of the one or more memory devices into one of two or more non-uniform memory architecture performance domains according to at least one characteristic and providing (170) the information on the at least one characteristic with information on the categorization.

Another example (e.g., example 26) relates to a previous example (e.g., example 25) or to any other example, further comprising that the method comprises determining (120) at least two characteristics for each memory device, and categorizing (130), separately for each of the at least two characteristics, each of the one or more memory devices into one of two or more non-uniform memory architecture performance domains for the respective characteristic.

Another example (e.g., example 27) relates to a previous example (e.g., one of the examples 20 to 26) or to any other example, further comprising that the method comprises determining (120) the at least one characteristic at least partially by running (122) one or more pre-defined performance evaluation tests on the one or more memory devices.

Another example (e.g., example 28) relates to a previous example (e.g., example 27) or to any other example, further comprising that the method comprises determining (120) at least one of a latency, a throughput between the at least one processor and the memory device, an error rate, and a power consumption of the memory device by measuring (124) the respective latency, throughput, error rate or power consumption.

Another example (e.g., example 29) relates to a previous example (e.g., one of the examples 20 to 28) or to any other example, further comprising that method comprises determining (120) the at least one characteristic of a memory device at least partially by estimating (126) the characteristic based on at least one of a memory technology used by the memory device, a form factor used by the memory device, a connectivity of the memory device, a known reliability of the memory device and a known power-consumption of the memory device.

Another example (e.g., example 30) relates to a previous example (e.g., one of the examples 20 to 29) or to any other example, further comprising that the method comprises updating (140) the information on the at least one characteristic based on runtime re-evaluation of the at least one characteristic.

Another example (e.g., example 31) relates to a previous example (e.g., one of the examples 20 to 30) or to any other example, further comprising that the method comprises determining (150) a temporal availability of the one or more memory devices, and to provide the information on the at least one characteristic with information on the temporal availability of the one or more memory devices.

Another example (e.g., example 32) relates to a previous example (e.g., one of the examples 20 to 31) or to any other example, further comprising that the method comprises determining (160) information on a shared use of the one or more memory devices, and to provide the information on the at least one characteristic with information on the shared use of the one or more memory devices.

Another example (e.g., example 33) relates to a previous example (e.g., one of the examples 20 to 32) or to any other example, further comprising that the serial-based processor-to-memory interface is a serial communication-based Peripheral Component Interface express (PCIe)-based interface.

Another example (e.g., example 34) relates to a previous example (e.g., one of the examples 20 to 33) or to any other example, further comprising that the serial communication-based processor-to-memory interface is a Compute Express Link (CXL) interface.

Another example (e.g., example 35) relates to a baseband management controller for a computer system (100), the baseband management controller being configured to perform the method according to one of the examples 20 to 34.

Another example (e.g., example 36) relates to a computer system comprising the baseband management controller according to example 35.

Another example (e.g., example 37) relates to a computer system being configured to perform the method according to one of the examples 20 to 34.

An example (e.g., example 38) relates to a non-transitory, computer-readable medium comprising a program code that, when the program code is executed on at least one processor, causes the at least one processor to obtain information on at least one characteristic of one or more memory devices of a non-uniform memory architecture used by a computer system as part of information characterizing the non-uniform memory architecture, the information on the at least one characteristic being based on an estimate or measurement of the performance of the one or more memory devices as observed by the at least one processor, the one or more memory devices being connected to the at least one processor of the computer system via a serial communication-based processor-to-memory interface, and provide derived information on the at least one characteristic of one or more memory devices for use in memory allocation.

Another example (e.g., example 39) relates to a previous example (e.g., example 38) or to any other example, further comprising a program code that, when the program code is executed on at least one processor, causes the at least one processor to obtain the information on the at least one characteristic from at least one of a System Resource Affinity Table (SRAT), Heterogeneous Memory Attribute Table (HMAT) and System Locality Distance Information Table (SLIT).

Another example (e.g., example 40) relates to a previous example (e.g., one of the examples 38 or 39) or to any other example, further comprising that the information on the at least one characteristic of the one or more memory devices is obtained, for each memory device, with at least two characteristics.

Another example (e.g., example 41) relates to a previous example (e.g., one of the examples 38 to 40) or to any other example, further comprising that the information on the at least one characteristic comprises information on a categorization of the one or more memory devices in one of two or more non-uniform memory architecture performance domains according to at least one characteristic, the non-transitory, computer-readable medium comprising a program code that, when the program code is executed on at least one processor, causes the at least one processor to provide the derived information with the information on the categorization of the one or more memory devices.

Another example (e.g., example 42) relates to a previous example (e.g., one of the examples 38 to 41) or to any other example, further comprising a program code that, when the program code is executed on at least one processor, causes the at least one processor to determine an update to the information on the at least one characteristic being based on runtime re-evaluation of the at least one characteristic, and to notify at least one software application having performed memory allocation based on the derived information on the at least one characteristic of the update.

Another example (e.g., example 43) relates to a previous example (e.g., one of the examples 38 to 42) or to any other example, further comprising a program code that, when the program code is executed on at least one processor, causes the at least one processor to obtain the information on the at least one characteristic with information on a temporal availability of the one or more memory devices, and to provide the derived information on the at least one characteristic with the information on the temporal availability.

Another example (e.g., example 44) relates to a previous example (e.g., one of the examples 38 to 42) or to any other example, further comprising a program code that, when the program code is executed on at least one processor, causes the at least one processor to obtain the information on the at least one characteristic with information on a shared use of the one or more memory devices, and to provide the derived information on the at least one characteristic with the information on the shared use.

Another example (e.g., example 45) relates to a previous example (e.g., one of the examples 38 to 44) or to any other example, further comprising a program code that, when the program code is executed on at least one processor, causes the at least one processor to obtain the information on the at least one characteristic from a baseband management controller.

Another example (e.g., example 46) relates to a previous example (e.g., one of the examples 38 to 45) or to any other example, further comprising that the program code is program code of an operating system.

Another example (e.g., example 47) relates to a previous example (e.g., one of the examples 38 to 45) or to any other example, further comprising that the program code is program code of a hypervisor.

An example (e.g., example 48) relates to an apparatus (20) for a computer system (100), the apparatus (20) comprising interface circuitry (22), machine-readable instructions, and processing circuitry (24) to execute the machine-readable instructions to obtain information on at least one characteristic of one or more memory devices (104, 106) of a non-uniform memory architecture used by the computer system (100) as part of information characterizing the non-uniform memory architecture, the information on the at least one characteristic being based on an estimate or measurement of the performance of the one or more memory devices as observed by at least one processor (102) of the computer system (100), the one or more memory devices being connected to the at least one processor of the computer system via a serial communication-based processor-to-memory interface, and provide derived information on the at least one characteristic of one or more memory devices for use in memory allocation.

An example (e.g., example 49) relates to an apparatus (20) for a computer system (100), the apparatus (20) comprising processing circuitry (24) configured to obtain information on at least one characteristic of one or more memory devices (104, 106) of a non-uniform memory architecture used by the computer system (100) as part of information characterizing the non-uniform memory architecture, the information on the at least one characteristic being based on an estimate or measurement of the performance of the one or more memory devices as observed by at least one processor (102) of the computer system (100), the one or more memory devices being connected to the at least one processor of the computer system via a serial communication-based processor-to-memory interface, and provide derived information on the at least one characteristic of one or more memory devices for use in memory allocation.

An example (e.g., example 50) relates to a device (20) for a computer system (100), the device (20) comprising means for processing (24) for obtaining information on at least one characteristic of one or more memory devices (104, 106) of a non-uniform memory architecture used by the computer system (100) as part of information characterizing the non-uniform memory architecture, the information on the at least one characteristic being based on an estimate or measurement of the performance of the one or more memory devices as observed by at least one processor (102) of the computer system (100), the one or more memory devices being connected to the at least one processor of the computer system via a serial communication-based processor-to-memory interface, and providing derived information on the at least one characteristic of one or more memory devices for use in memory allocation.

Another example (e.g., example 51) relates to a computer system (100) comprising the apparatus (20) or device (20) according to one of the examples 48 to 50.

Another example (e.g., example 52) relates to the computer system (100) according to example 51, further comprising the apparatus (10), device (10) or baseband management controller according to one of the examples 1 to 18.

An example (e.g., example 53) relates to a method comprising obtaining (210) information on at least one characteristic of one or more memory devices of a non-uniform memory architecture used by a computer system as part of information characterizing the non-uniform memory architecture, the information on the at least one characteristic being based on an estimate or measurement of the performance of the one or more memory devices as observed by the at least one processor, the one or more memory devices being connected to the at least one processor of the computer system via a serial communication-based processor-to-memory interface, and providing (220) derived information on the at least one characteristic of one or more memory devices for use in memory allocation.

Another example (e.g., example 54) relates to a previous example (e.g., example 53) or to any other example, further comprising that the information on the at least one characteristic is obtained from at least one of a System Resource Affinity Table (SRAT), Heterogeneous Memory Attribute Table (HMAT) and System Locality Distance Information Table (SLIT).

Another example (e.g., example 55) relates to a previous example (e.g., one of the examples 53 or 54) or to any other example, further comprising that the information on the at least one characteristic of the one or more memory devices is obtained, for each memory device, with at least two characteristics.

Another example (e.g., example 56) relates to a previous example (e.g., one of the examples 53 to 55) or to any other example, further comprising that the information on the at least one characteristic comprises information on a categorization of the one or more memory devices in one of two or more non-uniform memory architecture performance domains according to at least one characteristic, wherein the derived information is provided with the information on the categorization of the one or more memory devices.

Another example (e.g., example 57) relates to a previous example (e.g., one of the examples 53 to 56) or to any other example, further comprising that the method comprises determining (230) an update to the information on the at least one characteristic being based on runtime re-evaluation of the at least one characteristic and notifying (240) at least one software application having performed memory allocation based on the derived information on the at least one characteristic of the update.

Another example (e.g., example 58) relates to a previous example (e.g., one of the examples 53 to 57) or to any other example, further comprising that the information on the at least one characteristic is obtained with information on a temporal availability of the one or more memory devices, and the derived information on the at least one characteristic is provided with the information on the temporal availability.

Another example (e.g., example 59) relates to a previous example (e.g., one of the examples 53 to 57) or to any other example, further comprising that the information on the at least one characteristic is obtained with information on a shared use of the one or more memory devices, and the derived information on the at least one characteristic is provided with the information on the shared use.

Another example (e.g., example 60) relates to a previous example (e.g., one of the examples 53 to 59) or to any other example, further comprising that the information on the at least one characteristic is obtained from a baseband management controller.

Another example (e.g., example 61) relates to a previous example (e.g., one of the examples 53 to 60) or to any other example, further comprising that the method is performed by an operating system.

Another example (e.g., example 62) relates to a previous example (e.g., one of the examples 53 to 60) or to any other example, further comprising that the method is performed by a hypervisor.

Another example (e.g., example 63) relates to a computer system (100) being configured to perform the method according to one of the examples 53 to 62.

Another example (e.g., example 64) relates to the computer system (100) according to example 63, wherein the computer system is further configured to perform the method according to one of the examples 20 to 34.

Another example (e.g., example 65) relates to a non-transitory, computer-readable medium comprising a program code that, when the program code is executed on a processor, a computer, or a programmable hardware component, causes the processor, computer, or programmable hardware component to perform at least one of the method of one of the examples 20 to 34 and the method of one of the examples 53 to 62.

Another example (e.g., example 66) relates to a non-transitory machine-readable storage medium including program code, when executed, to cause a machine to perform at least one of the method of one of the examples 20 to 34 and the method of one of the examples 53 to 62.

Another example (e.g., example 67) relates to a computer program having a program code for performing at least one of the method of one of the examples 20 to 34 and the method of one of the examples 53 to 62 when the computer program is executed on a computer, a processor, or a programmable hardware component.

Another example (e.g., example 67) relates to machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor-or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a computer system, the apparatus comprising interface circuitry, machine-readable instructions, and processing circuitry to execute the machine-readable instructions to:
determine a presence of one or more memory devices connected to at least one processor of the computer system via a serial communication-based processor-to-memory interface, the one or more memory devices being part of a non-uniform memory architecture used by the computer system;
determine at least one characteristic for the one or more memory devices by estimating or measuring a performance of the one or more memory devices as observed by the at least one processor; and
provide information on the at least one characteristic of the one or more memory devices as part of information characterizing the non-uniform memory architecture.

2. The apparatus according to claim 1, wherein the information on the at least one characteristic is provided as part of at least one of a System Resource Affinity Table (SRAT), Heterogeneous Memory Attribute Table (HMAT) and System Locality Distance Information Table (SLIT).

3. The apparatus according to claim 1, wherein the information on the at least one characteristic of the one or more memory devices is provided, for each memory device, with at least two characteristics.

4. The apparatus according to claim 3, wherein the information on the at least one characteristic of the one or more memory devices is provided, for each memory device, with at least two of a latency between the at least one processor and the memory device, a throughput between the at least one processor and the memory device, a power consumption caused by using the memory device by the at least one processor, a throughput between the at least one processor and the memory device per computer consumption, and an error rate of the use of the memory device by the one or more processors.

5. The apparatus according to claim 1, wherein the processing circuitry is to execute the machine-readable instructions to provide the information on the at least one characteristic to at least one of an operating system of the computer system and a hypervisor of the computer system.

6. The apparatus according to claim 1, wherein the processing circuitry is to execute the machine-readable instructions to categorize each of the one or more memory devices into one of two or more non-uniform memory architecture performance domains according to at least one characteristic, and to provide the information on the at least one characteristic with information on the categorization.

7. The apparatus according to claim 6, wherein the processing circuitry is to execute the machine-readable instructions to determine at least two characteristics for each memory device, and to categorize, separately for each of the at least two characteristics, each of the one or more memory devices into one of two or more non-uniform memory architecture performance domains for the respective characteristic.

8. The apparatus according to claim 1, wherein the processing circuitry is to execute the machine-readable instructions to determine the at least one characteristic at least partially by running one or more pre-defined performance evaluation tests on the one or more memory devices.

9. The apparatus according to claim 8, wherein the processing circuitry is to execute the machine-readable instructions to determine at least one of a latency, a throughput between the at least one processor and the memory device, an error rate, and a power consumption of the memory device by measuring the respective latency, throughput, error rate or power consumption.

10. The apparatus according to claim 1, wherein the processing circuitry is to execute the machine-readable instructions to determine the at least one characteristic of a memory device at least partially by estimating the characteristic based on at least one of a memory technology used by the memory device, a form factor used by the memory device, a connectivity of the memory device, a known reliability of the memory device and a known power-consumption of the memory device.

11. The apparatus according to claim 1, wherein the processing circuitry is to execute the machine-readable instructions to update the information on the at least one characteristic based on runtime re-evaluation of the at least one characteristic.

12. The apparatus according to claim 1, wherein the processing circuitry is to execute the machine-readable instructions to determine a temporal availability of the one or more memory devices, and to provide the information on the at least one characteristic with information on the temporal availability of the one or more memory devices.

13. The apparatus according to claim 1, wherein the processing circuitry is to execute the machine-readable instructions to determine information on a shared use of the one or more memory devices, and to provide the information on the at least one characteristic with information on the shared use of the one or more memory devices.

14. The apparatus according to claim 1, wherein the serial-based processor-to-memory interface is a serial communication-based Peripheral Component Interface express (PCIe)-based interface.

15. The apparatus according to claim 1, wherein the serial communication-based processor-to-memory interface is a Compute Express Link (CXL) interface.

16. The apparatus according to claim 1, wherein the apparatus or device is a baseband management controller.

17. A method comprising:
obtaining information on at least one characteristic of one or more memory devices of a non-uniform memory architecture used by a computer system as part of information characterizing the non-uniform memory architecture, the information on the at least one characteristic being based on an estimate or measurement of the performance of the one or more memory devices as observed by the at least one processor, the one or more memory devices being connected to the at least one processor of the computer system via a serial communication-based processor-to-memory interface; and
providing derived information on the at least one characteristic of one or more memory devices for use in memory allocation.

18. The method according to claim 17, wherein the method comprises determining an update to the information on the at least one characteristic being based on runtime re-evaluation of the at least one characteristic and notifying at least one software application having performed memory allocation based on the derived information on the at least one characteristic of the update.

19. The method according to claim 17, wherein the information on the at least one characteristic is obtained with information on at least one of a temporal availability of the one or more memory devices and a shared use of the one or more memory device, and the derived information on the at least one characteristic is provided with the information on the temporal availability or information on the shared used.

20. A non-transitory, computer-readable medium comprising a program code that, when the program code is executed on a processor, a computer, or a programmable hardware component, causes the processor, computer, or programmable hardware component to perform the method of claim 17.
